(19) United States
(12) Patent Application Publication
(10) Pub. No.: US 2026/0370690 A1
(43) Pub. Date: Nov. 19, 2026

(54) AUTOMATICALLY DETECTING DISCREPANCIES BETWEEN PRIVACY POLICIES AND PRIVACY LABELS

(71) Applicant: Carnegie Mellon University, Pittsburgh, PA (US)

(72) Inventors: Akshath Jain, Pittsburgh, PA (US); Norman Sadeh, Pittsburgh, PA (US)

(21) Appl. No.: 19/490,751

(22) PCT Filed: Jun. 6, 2024
(86) PCT No.: PCT/US2024/032887

§ 371 Date: Dec. 5, 2025

Related U.S. Application Data
(60) Provisional application No. 63/471,420, filed on Jun. 6, 2023.

(51) Int. Cl. H04L 9/40; G06N 20/00

(52) U.S. Cl. CPC H04L 63/20; G06N 20/00

(57) ABSTRACT

Computer systems and computer-implemented methods identify potential discrepancies between data practice disclosures made in a data practice policy and a data practice label for a data system. The data system collects or captures data about or for a user of the data system or any other person The method can also comprise the step of comparing, by the computer system, the prediction for the given data practice with an entry in the data practice label for the data system to identify a possible discrepancy between the prediction and the data practice label. The classifier can be trained via machine learning to make the predictions. The classifier could comprise a classifier for each data practice covered by the data label or a foundation model, such as large language model, that is adapted to make the predictions about a data system's data practice label.

### PRIORITY CLAIM

This application claims priority to U.S. provisional patent application Ser. No. 63/471,420, filed Jun. 6, 2023, entitled “ATLAS: Automatically Detecting Discrepancies Between Privacy Policies and Privacy Labels,” which is incorporated herein by reference in its entirety.

### BACKGROUND

In December 2020, Apple, Inc. began requiring that all app developers include “App Privacy Details” describing their apps' data practices when uploading new versions of their apps to the iOS App Store. Along with the introduction of similar requirements in the Google Play store the following year, this was arguably the largest adoption to date of what will be referred to herein as “data practice labels.” Data practice labels are summaries of key data practices associated with a system or technology. They may also be referred to as “privacy labels,” “privacy nutrition labels,” “data labels,” or “safety labels,” among other terms.

Adoption of data practice labels is becoming increasingly popular (e.g., see also Amazon Appstore) and is not limited to mobile apps. Instead, data practice labels can be used for a range of other systems and technologies that collect data (e.g., Internet of Things systems and devices, websites, and more).

Apple, for example, has taken a multilayered approach to data practice labels: users first encounter a short version of a label in the iOS App Store, which may also be referred to as a “compact privacy label,” but can choose to “See Details,” to access a more detailed summary of the app's data practices. The iOS privacy label consists of four parts. First, developers declare the data type(s) being collected by their app. Then, for each data type, developers are required to report how the data type is being used. Next, developers must specify if the data type is “Linked to You,” which indicates that it is being collected non-anonymously. Finally, if the developer declares whether the data type is “Linked to You,” then they must declare if it is “Used to Track You,” which indicates linking collected data for targeted advertising or third-party data sharing.

Similarly, Google requires “safety labels” for applications in the Google Play store to provide users with a summary of how individual mobile apps manage user data. Like the Apple IOS App Store, users in the Google Play Store can encounter a short version of a data practice label in the Play Store, but can choose to see more details, which provides a more detailed summary of an app's data practices. For example, if a developer declares that a data type is shared with other companies or organizations, that data type will be labeled as “Shared Data.” The “Shared Data” category may further clarify for what purposes the data is being shared, as well. For example, e-mail addresses may be shared for advertising and analytics, an address may be used for developer communication, and phone numbers may be used for fraud protection. Alternatively, the developer may declare that a data type may be collected but not shared, which may be labeled as “Collected Data.” Finally, the developer may also declare other Security Practices engaged in by the application, such as whether the data is encrypted in transit and whether the data can be deleted.

While data practice labels are intended to help inform end-users about a system's data practices, they are not without issue. Recent research suggests that developers face challenges in creating accurate data practice labels. For example, misconceptions of developers about data practice labels have been shown to result in under-or over-reporting data practices, such as data collection. A previously conducted study found, via dynamic analysis of a small subset of mobile apps, that approximately 16% of mobile apps violated their own data practice labels by transmitting data without declaration.

Research has shown that tools can be developed to aid developers in generating more accurate data practice labels. For example, tools such as Privacy Label Wiz aid developers in creating data practice labels for iOS apps by statically analyzing iOS app source code for signatures such as plist permission strings, import statements, and class instantiations and use their findings to help developers create more accurate data practice labels. These tools can help developers better comply with regulations, such as the European Union's General Data Protection Regulation (“GDPR”) or the California Consumer Privacy Act (“CCPA”), which require accurate data practice disclosures.

Regulatory requirements for data practice disclosures, such as privacy disclosures, can vary by jurisdiction. For example, the state of California and the European Union-two of the largest digital markets-have stringent privacy disclosure requirements. California requires compliance through the California Consumer Privacy Act (“CCPA”) and the European Union through GDPR. Many other countries throughout the world have adopted somewhat similar requirements over the past few years, and more are expected to follow suit in the near future. Failure to provide accurate privacy disclosures in jurisdictions with these requirements can result in significant legal ramifications.

Accordingly, there is a need to ensure that data systems are compliant with regulations and that disclosures made in data practice policies and data labels are accurate. In general, any privacy regulation that mandates the disclosure of some data practices requires that these disclosures be accurate. In the context of an individual data system, owners and developers of a data system may benefit from a system capable of identifying potential discrepancies between the data practices listed on a data practice label and the data practices disclosed in a data practice policy to verify the accuracy of the data practice label and to ensure compliance with any relevant laws or regulations. Similarly, on a larger scale, digital platforms, such as the iOS App Store or Google Play store or any other platform publicizing, rating, distributing and/or selling data systems (e.g., store selling Internet of Things devices or systems, smart city registry, store distributing browser extensions/plugins, distributor of smart home technologies, distributor of AI technologies, consumer rating portal, etc.), may benefit from a method or system to automatically analyze at scale data practice disclosures for potential discrepancies. Potential discrepancies can be used to automatically flag data systems for further analysis, whether manual or automated. They can be combined with other possible signals indicative of potential compliance issues for manual and/or automated analysis (e.g., static or dynamic code analysis, reputation/history of a publisher/developer, target audience such as whether a system is directed to children, popularity of the system, history of the system, intended use of the system, sensitivity of the data being collected or shared, entities with which data is shared and where these entities are located, other sources of information about the publisher/developer or data system, etc.).

### SUMMARY

In one general aspect, the present invention is directed to computer systems and computer-implemented methods for identifying potential discrepancies between data practice disclosures made in a data practice policy and a data practice label for a data system. The data system could be, for example, a mobile app or another type of data system that collects or captures data about or for a user of the data system or any other person whose data might be collected (e.g., someone passing by a camera or coming near a smart speaker even if they are not the user or owner of these devices or systems). The method can also comprise the step of comparing, by the computer system, the prediction for the given data practice with an entry in the data practice label for the data system to identify a possible discrepancy between the prediction and the data practice label.

In various implementations, the classifier can be trained via machine learning to make the predictions. For example, the classifier could comprise a classifier for each data practice covered by the data label. In yet other embodiments, the classifier could comprise a foundation model, such as large language model, that is adapted to make the predictions about a data system's data practice label. This could include using prompt engineering and/or additional training to ask the foundation model to determine whether a particular data practice policy (or one or more excerpts of a data practice policy) for a given data system is indicative of the data system likely to have a particular value for a particular data label entry (e.g., disclosing that data system collections location information, or disclosing that the data system uses location to track the user, or disclosing that the system never shares location information with third parties, disclosing that the data system complies with a particular security standard). The additional training could also include training the model to take into account relevant regulations such as privacy regulations and particular data practice disclosures mandated by these regulations.

Identification of an attribute(s) for a given data practice in the data practice policy can indicate that the data system engages in, or is permitted to engage in, the data practice.

Absence of such attributes, or attributes to the contrary, in the data practice policy can indicate that the data system does not engage is the data practice.

The systems and method of the present invention can be used to analyze data practice labels for data systems for accuracy. A developer of a data system can update the data practice label of the data system based on the discrepancy analysis results so that end users of the data system have a more accurate description of the data practices of the data system.

Embodiments of the present invention could be used, for example, by a platform for data systems to monitor the data labels for the data systems publicized or distributed or rated by the platform; by developers of data systems to generate more accurate data labels for their data systems; and/or by regulators to identify potential compliance issues. These and other benefits of the present invention are apparent from the description herein.

### FIGURES

Various embodiments of the present invention are described herein by way of example in connection with the following figures.

FIG. 1 is an illustration according to various embodiments of the present invention by which a machine learning system can be trained. Other embodiments may rely on different forms of training, including more generic training such as that used to train foundation models.

FIG. 2 is an illustration according to various embodiments of the present invention of an inference of the machine learning system after training.

FIG. 3 is an illustration according to various embodiments of the present invention by which discrepancies between a data practice label and a data practice policy are determined.

FIG. 4 is a diagram of a data collection pipeline according to various embodiments of the present invention.

FIGS. 5 and 6 are diagrams of computer systems that may be used in accordance with various embodiments of the present invention. Note that the NLP module may consist of one or more classifiers and/or may rely on foundation models. Note also that some elements in this diagram such as a text summary of the data policy are optional and may not be present in some embodiments of this invention.

FIGS. 7A and 7B provide examples of iOS privacy labels.

FIG. 8 is a diagram of a foundation model that may be used in accordance with various embodiments of the present invention.

### DESCRIPTION

Although generally described herein with respect to mobile applications (e.g., apps for a mobile device) and privacy policies, it should be understood that the present invention is applicable to any data system subject to any data practice policy. As used herein, data systems include, but are not limited to mobile apps, IoT devices (e.g. smart speakers, smart TVs, smart cars, smart homes), websites, credit cards or other digital payment platforms, electronic devices (e.g., cars, cameras, games, etc.), IoT systems, smart city technologies or systems, smart home technologies or systems, smart office technologies or systems, enterprise systems, government services or systems, customer-facing services or systems that capture data, etc.

Further, under many different regulatory regimes, organizations are required to disclose their data practices. This often takes the form of a “privacy policy” or “privacy notice”. Such a policy or notice may be in the form of a flat document or may be organized as a multi-layered document such as a document that allows users to navigate the text through hyperlinks. By extension, the use of the term “data practice policy” herein refers to these and other types of disclosure statements, whether purely text-based or using other modes of communication including but not limited to audio, graphics, or video. In addition, a data practice policy, as used herein, can also include other documents or sources of information that may include disclosures about the data practices of a data system. Such data practice policy can include, but is not limited to, a privacy policy, a data usage policy, a terms of service policy, a terms of use policy, a set terms and conditions, a governmental regulation or legislation, a plurality of policy resources including, but not limited to, the policies listed herein, or any other equivalent document where an organization many provide information about its data practices as an additional disclosure beyond those made in a privacy policy.

This may also include additional documents detailing an organizations security practices or additional rights, including but not necessarily limited to data rights, provided to consumers. In the present invention a data practice policy may also refer to just one or more excerpts of these documents or sources of information.

Additionally, as used herein, data practices are defined as the way in which a data system collects and handles data. This includes, but is not limited to, what data the data system collects, for what purpose the data are being collected, with whom that data might be shared and for what purpose, for how long the data are retained, where the data are retained, in what form the data are retained (e.g., raw data, featured data, (pseudo)anonymized data, anonymized data, anonymous data, whether data might be linked or not to individuals, whether data might be re-identifiable, etc.), etc. Data practices also include what rights the users of data systems (i.e., the subject of the data) might be given such as, but not limited to, the right to opt-in or opt-out of the collection and/or processing of some data, the right to opt-in or opt-out of collection and processing for certain purposes only, the right to opt-in or opt-out of the sharing one's data with third parties, the right to opt-in or out of the retention of one's data (possibly beyond a certain minimum duration), the right to delete one's data, the right to review one's data, the right to have one's data corrected if it is erroneous, the right to contest the accuracy of some data, the right to object or agree to the use of one's data to train machine learning models, etc. Further, data practices can also include details about the security practices associated with the collection, storing, processing, and transmission of data such as, but not limited to, whether data are encrypted and whether security practices extend to the systems used to store, process and transmit data. For example, this may include determining whether organization(s) responsible for the collection, processing or transmission of data adhere to best practices and which best practices they follow (e.g. whether they follow a particular standard and/or have been certified).

Further, as used herein, a data practice label refers to a collection of entries or fields summarizing key attributes of data practices of a data system, such as those data practices people are known to care about or data practices that organizations are expected or required to report.

Although discussed herein in reference to Apple's decision to require data practice labels for the applications in the Apple App Store, other digital platforms, such as the Google Play Store, also require data practice labels corresponding to data practice policies on available applications. Additionally, it is anticipated that the use of data practice labels will become more prevalent over time. This may occur via laws or regulations passed by a governmental entity, or it may be initiated by private business entities. Data practice labels are already being deployed or developed in a number of other contexts (e.g., IoT consumer devices, smart city technologies, smart office technologies, etc.).

Natural Language Processing (NLP) can be used to analyze hundreds of thousands of data practice policies for data systems that would otherwise take human annotators years to accomplish. Past research has detailed the effectiveness of using NLP techniques to analyze data practice policies for compliance analysis using high-quality annotator-labeled data (i.e., annotations per policy segment) from the APP-350 corpus. The identification of data practice statements may be formulated as a classification problem using one classifier per data practice.

In one aspect, the present invention can formulate identification of data practice attributes as a document classification problem instead of focusing on policy segments.

Additionally, instead of using annotator-labeled data (such as from the APP-350 corpus), the present invention can use developer reported data practice labels as ground truth to describe the text of data practice policies. While data practice labels for data systems may not always be fully consistent with the text of data practice policies for the data systems (e.g., developers may struggle to always create accurate data practice labels, the data practice policies may include disclosures that do not apply to the specific data system being considered, and the data practice policies themselves may be inaccurate), they have proven to collectively be a very good source of ground truth when it comes to building classifiers to predict data practice label entries based on the text of data practice policies. Finally, the present invention can use additional state-of-the-art model architectures for document classification.

Document classification is an extensively researched field. Current state-of-the-art techniques are based on the transformer model (such as BERT and ROBERTa), which sidesteps traditional methods such as recurrence. While documents, such as those comprising data practice policies, are typically longer than the maximum sequence length allowed by models, such as BERT and ROBERTa, which presently have a limit of 512 tokens, this limit can be expected to relax over time. The Longformer model currently increases input sequence length to 4096 tokens, which is better suited for document classification. However, transformer-based models have large computational overhead. The RegLSTM (Regularized Long Short-Term Memory) model can be a lightweight alternative for document classification. Rapid progress in Generative AI continues to yield new advances and increasing powerful foundation models, which can also be further trained to meet the requirements of diverse domains. Recent research has demonstrated the power of foundation models, including Large Language Models, when it comes to developing classifiers capable of predicting label entries associated with common data practice labels. While the method or system disclosed herein can be used to identify potential discrepancies between the data label and the data practice policy of one particular data system, the same method or system can also be used to analyze a large number of data systems. A distributed pipeline can be used for automated analysis of data practice disclosures in data systems. In various embodiments, a candidate list of data systems to analyze can be initially identified. One method for data system discovery may rely on crawling digital platforms, such as mobile app stores, for data system discovery. For example, Apple publishes a categorized, alphabetical list of all available iOS Apps, including popular apps per category, such that one could systematically crawl and scrape the website with the published list to assemble a list of unique apps. For example, as of Jan. 29, 2023, 918,293 unique apps were available on the United States iOS App Store and, of those apps, 4,846 are classified as popular apps.

Next, a sampling strategy can optionally be devised to pick a subset of the data systems to analyze-if one is only interested in a particular sample. Conducting a simple random sample of the entire digital platform, such as an app store, may be the easiest way to generate a representative sample of the entire digital platform. However, in the case of mobile applications, for example, this approach is likely to miss heavy hitters, such as frequently downloaded apps that are more likely to be present on users' devices, i.e., popular apps.

Conversely, sampling only popular apps may lead to a biased representation of the digital platform, as many apps are missed. Alternatively, a hybrid sampling strategy may be devised to create a set of apps likely to be present on users' devices and an unbiased representation of apps available on the digital platform. For example, based on the January 2023 data, all 4,846 popular apps may be sampled in addition to a randomly selected set of 350,000 non-popular apps. As a result, the final dataset could comprise, for example, 354,725 apps, as some app listings may be unable to be loaded. Other approaches to sampling systems may be based on entirely different criteria such as criteria that match the particular priorities of a regulatory agency (e.g., apps that are particularly popular, apps aimed at children, apps that collect particularly sensitive data, apps published by entities based in particular countries, etc.), priorities of a particular platform, priorities of a particular research group, priorities of a consumer protection agency, etc.

iOS apps are required to provide a URL to their privacy policy. However, in many cases, these URLs lead to landing pages, or other unrelated webpages. To accurately obtain privacy policies, a machine learning classifier, such as a logistic regression classifier, may be used to determine if pages were English-language privacy policies or in one or more specific target languages one is interested in. In one example, a corpus of 918 iOS app privacy policies was collected and labeled, of which 67.3% were legitimate privacy policies, and the rest were unrelated webpages. After training, a classifier in accordance with at least one aspect of the present invention was evaluated on an unseen test set with 64 positive examples and 42 negative examples. The classifier was able to achieve 98.1% accuracy with an F1 score of 98.4% (precision=100%, recall=96.9%). To run the system efficiently, only pages directly linked to by the provided privacy policy URL may be classified.

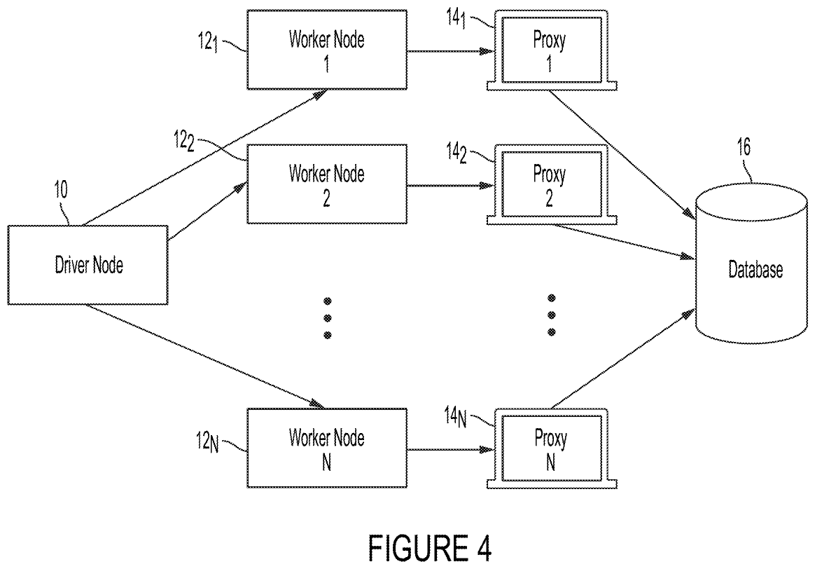

The scale of the data set may necessitate the design, development, and deployment of a highly parallelizable and distributed data collection pipeline. This can enable collection of all data within a relatively short window. An example of an infrastructure configured for this purpose is depicted in FIG. 4. A driver node 10 may be utilized to coordinate work between N worker nodes 12₁, 12₂, . . . , 12_{N}. Each worker node can run a headless Firefox browser, or some other suitable browser, to replicate a real-world browser. This gives the ability to capture dynamically loaded content and follow any webpage redirects-emulating the experience of a real user. To avoid rate-limiting, a pool of N proxy servers 14₁, 14₂, . . . , 14_{N} (one per worker) may be utilized to increase the number of available IP addresses. The SOCKS5 protocol may be used to connect worker nodes to proxies. After webpages were retrieved, they can be saved in a shared database 16. The database 16 may comprise a relational (e.g., SQL) database or a NoSQL database, such as a document-oriented database (e.g., MongoDB) or a key-valued database, for example. Other implementations of such a data pipeline can easily be employed in other embodiments.

Large scale data collection can require time. For example, data collection may span multiple days. Data collection may be completed in multiple phases. For example, data collection may be completed in two phases. Phase 1 may focus on downloading data system listings from the digital platform, and Phase 2 may focus on downloading data practice policies corresponding to the data systems. Different configurations may be used for each phase. For example, Phase 1 may utilize one driver node with 49 worker nodes and 49 proxies, whereas Phase 2 may use one driver node with 80 worker nodes and no proxies.

Proxies may not be required in Phase 2 because privacy policies are typically hosted on different domains, so rate-limiting (i.e., limiting, by the computer system, the number of requests per unit of time that a client may make) was not a concern.

Data collection may occur at different rates and require different amounts of time during different phases. For example, Phase 1 may run at a rate of approximately 21,000 apps per hour. If proxy servers require an interruption, such as a nightly-reboot cycle, the rate may diminish. Such interruptions may require manual intervention to resume. Additionally, if proxy servers are not responsive, the rate may further slow. For example, if 9 proxy servers were no longer responsive, the rate may slow to approximately 19,000 apps per hour. Phase 2 may have an average rate of 20,500 apps per hour. Further, Phases 1 and 2 may need to be rerun in an attempt to re-download app listings and privacy policies that timed out. As a result, 345,725 apps may be collected, for example.

Even though apps are generally required to link to privacy policies, a substantial number of apps may provide extraneous links instead. For examples, studies have shown that 5.0% of apps provide dead links. Moreover, 54.7% of apps provide links that led to extraneous webpages, such as landing pages, home pages, and 404s. Only 40.3% of apps provide direct links to legitimate privacy policies, which may be characterized as accessible privacy policies.

Next, the adoption rate of data practice labels may be analyzed. For example, Apple began requiring apps published or updated after December 2020 to include data practice labels, although researchers discovered that 62.5% of sampled apps provided data practice labels. A substantially higher number of apps provided accessible data practice policies.

Only 29.6% of apps (105,131 apps) provided both accessible data practice policies and data practice labels. This subset of apps may be the focus of a compliance analysis in accordance with the present disclosure. Finally, the most common types of reported data collection may be analyzed. The most common data type collected was Crash Data, followed by Product Interaction and Email Address. Gameplay Content was the second least reported type of data collected, even though Games were the most common type of app in the App Store. The distribution of collection across data types for popular apps approximately follows the same distribution as apps available in the broader App Store.

Whether analyzing a single data system such as a single mobile app or multiple data systems, classifiers can be used to predicted data labels for these systems from their data practice policies. In one embodiment, the task may be formulated as a supervised label document classification problem, where the input is a data practice policy for a mobile application (or data practice policy for some other data system), and the output is a set of data practice label entries such as entries corresponding to different attributes of the data practices associated with the data system. In one embodiment one may focus just on the 32 data collection practices included in iOS privacy labels. Those 32 data types whose disclosure is covered in the iOS privacy labels include: (1) contact info; (2) contacts; (3) health and fitness; (4) financial information; (5) location; (6) sensitive information; (7) user content; (8) browsing history; (9) search history; (10) identifiers; (11) purchases; (12) usage data; (13) diagnostics; (14) other data linked to you; (15) contact information not linked to you; (16) contacts not linked to you; (17) health and fitness not linked to you; (18) financial information not linked to you; (19) location not linked to you; (20) sensitive information not linked to you; (21) user content not linked to you; (22) browsing history not linked to you; (23) search history not linked to you; (24) identifiers not linked to you; (25) purchases not linked to you; (26) usage data not linked to you; (27) diagnostics not linked to you; (28) other data linked to you; (29) other data not linked to you; (30) game center information; (31) gameplay content; and (32) advertising data. It should be understood however that in other embodiments classifiers could be used to predict any of the different entries found in data practice labels, as discussed above and in other parts of this document. For instance, this approach may also be extended to include how the data types are used, for what purpose, for how long they are retained, whether they are shared with third parties and more. For example, additional classifiers may be created for each data type, such that each additional classifier can correspond to other attributes of the data practices associated with this data type as covered in a platform's label such as the iOS App Store labels. In a simple embodiment, predicting whether a given data type is collected may be treated as an independent binary classification problem: for examples, 32 models may be created, where each model is responsible for predicting the collection of a corresponding, single data type as required to be disclosed in the iOS app store labels. Alternatively, predicting some entries in a data label may benefit from being approach as a multi-class classification problem, where a given data label entry may admit more than two possible values such as “collected” or “not collected”.

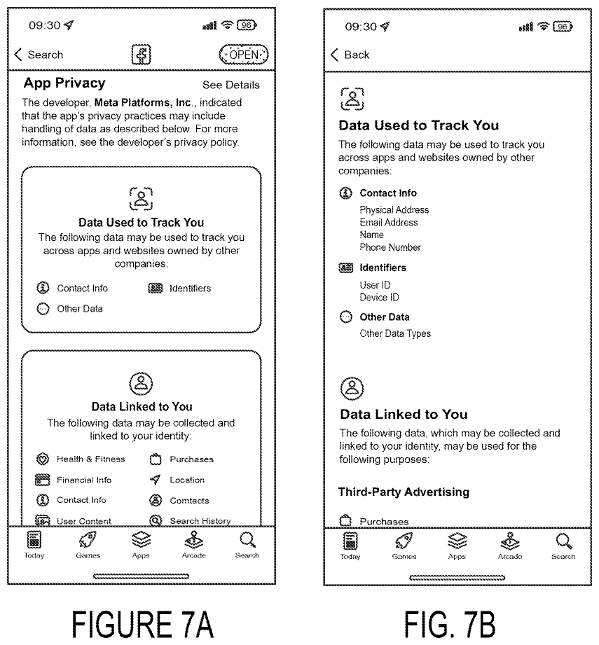

Examples of such data label entries may include entries such as the retention time associated with the collection of a particular data type where possible values may include “ephemeral” “less than 24 hours” “less than a week” “less than a month” “more than a month.” FIGS. 7A and 7B provide examples of privacy labels within the iOS app store.

FIG. 7A shows an overview of an app's privacy label and FIG. 7B depicts a more detailed summary of the app's data collection. The multilayered approach to privacy labels depicted in these figures: users first encounter a summarized version (FIG. 7A) but can choose to “See Details” (FIG. 7B), which provides a more comprehensive overview of the app's data collection practices. Of course, embodiments of the present invention are not limited to the iOS data label regime and the present invention can be used with other data label regimes and platforms, as described herein.

Unlike prior work, which has used data practice policy text labeled by human annotators, the present invention can rely on developer reported data practice labels to train classifiers to analyze data practice policies and predict data label entries. In one embodiment, training may involve in a first step filtering data systems to identify those which have both a data practice policy and a data practice label. In one particular instance focusing on a large corpus of iOS apps, this process yielded a total of 105,131 iOS apps. However, some data practice policies may be shared among multiple data systems. For instance, multiple related apps developed by a given organization may all share the same data practice policy among many of their data systems. In one embodiment, policy uniqueness may be determined by comparing data practice policy URLs for exact matches. For example, in one analysis of mobile apps in the iOS app store, 34.5% of policies were found to be duplicates, leaving 68,863 unique privacy policies. To ensure the development of accurate classifiers, care should be taken to preserve different data systems (e.g., different mobile apps) that admit differing data practice labels yet share the same data practice policy. One aspect of the present invention may assume that shared data practice policies are written generally enough to be applicable to multiple data systems. Data practice labels, however, are constructed on a per data system basis. Accordingly, these data practice labels may only reflect a subset of the data practice attributes disclosed in the shared data practice policy and, on occasions, the data practice policies may be vague about some specific data practice attributes (or data label entries) so as to accommodate different practices associated with the different data systems to which they apply. For instance, when considering data label entries intended to disclose the collection of different types of data, one should consider merging the data label entries of all data systems covered by a given data practice policy when training classifiers to predict whether the data practice policy is indicative of these data label entries. For instance, if two mobile apps share a privacy policy, one with a data label entry disclosing it collects the user's location and the other disclosing it does not, one would want to train a classifier to predict that the data label entry for collection of the user's location is disclosed by merging this particular data label entry (i.e., using a common data label, where this particular entry discloses the collection of the user's location). In other instances, such as instances where data label entries may admit more than two possible values (such as “may collect” versus “may not collect”), different rules can be developed to consolidate the corpus of pairs of data practice policies and corresponding data practice labels to maximize the accuracy of the training process. In some situations, constructing effective rules may require using heuristics that take into account the particular mix of policy-label pairs typically found on a given platform.

While using developer reported data practice labels may enable building a training corpus almost a hundred times larger than previous work, it may be expected that the data would not always be perfectly accurate (may be “noisy”).” Importance sampling techniques may be used to help reduce noise when creating training and testing datasets. With importance sampling, the expected value of a function is approximated under one probability distribution by sampling from another distribution, called the “importance distribution,” which has more mass where the function has higher values. This way, samples are more likely to contribute meaningfully to the estimation of the expected value. In one embodiment, if we limit ourselves to data practice labels that have to do with whether a given data practice occurs or not, when conducting importance sampling, a Positive instance may be defined as a data practice policy associated with a data practice label that reported a particular data practice as occurring. A Negative instance may be defined as where the data practice is reported to not occur.

For example, a random sample of the data practice label disclosing whether the (user's) Name data type is collected helps illustrate how noisy the underlying data might be. In this example, 500 policies whose data practice label declared collection of Name may be randomly sampled, as well as 500 policies that did not. In one embodicment, an embedding from each policy may then be extracted using TF-IDF vectorization and created a two-dimensional representation using t-SNE. TF-IDF (Term Frequency-Inverse Document Frequency) vectorization is a technique used in natural language processing (NLP) to transform text documents into numerical vectors. Term Frequency (TF) can be used to measure how frequently a term occurs in a document. It can be calculated by dividing the number of times a term appears in a document by the total number of terms in the document. TF increases with the number of occurrences of the term within the document. Inverse Document Frequency (IDF) can be used to measure the importance of a term in the entire corpus. It can be calculated by dividing the total number of documents by the number of documents containing the term, then taking the logarithm of that quotient. IDF decreases with the number of documents containing the term. TF-IDF can then be obtained by multiplying the TF and IDF scores for each term. It reflects how important a word is to a document within a corpus. t-SNE (t-distributed Stochastic Neighbor Embedding) is a dimensionality reduction technique primarily used for visualizing high-dimensional data in a lower-dimensional space, typically two or three dimensions. It is particularly effective at capturing the underlying structure of the data and revealing clusters or patterns that might not be easily visible in the original high-dimensional space. For each pair of data points in the high-dimensional space, t-SNE computes conditional probabilities that measure the similarity between them. These probabilities can be based on the Gaussian distribution centered at each data point. Then, t-SNE aims to represent these similarities in a lower-dimensional space while preserving the local structure of the data as much as possible. It achieves this by minimizing the Kullback-Leibler divergence between the conditional probabilities of the high-dimensional space and the probabilities of the corresponding points in the lower-dimensional space. Then, t-SNE can employ gradient descent optimization to find the optimal configuration of points in the lower-dimensional space that best represents the similarities between data points.

In some instances, there could possibly be significant overlap between positive and negative instances, such that there is no clear distinction between the two groups; this may suggest that many policies might be mislabeled. However, natural clusters may tend to appear within the randomly sampled data. In one embodiments, points can be clustered using DBSCAN-since the number of clusters may not be known a priori and the underlying data can contain some noise-after performing Latent Semantic Analysis (LSA) on the high dimensional TF-IDF embeddings. LSA can be performed by using TruncatedSVD to project the high-dimensional data onto a number of components, such as, for example, 10 or more components. These clusters should have semantically similar data practice policies and could, therefore, be considered to all have the same data practice label (either positive or negative). For example, if a cluster had 20 positive instances and 5 negative instances, then the negative instances could potentially be mislabeled, since the content of their data practice policies were similar to many positive instances.

The clusters may then be assigned a positive or negative label by conducting a two-proportion z-test that compares the incidence of positive to negative labels within a cluster. If a cluster has a statistically significantly larger proportion (i.e., p<0.05) of one class than the other, the cluster can be assigned the label of the more prominent class. In cases where determining cluster labels was inconclusive (i.e., p≥0.05), the cluster may be disregarded entirely. Centroids may then be computed for all positive and negative clusters.

Finally, to construct a dataset of size N, with N/2 positive and N/2 negative examples, a random oversample of Ninstances per class may be conducted. Then, for each class, the N/2 examples closest to the class centroids may be selected, effectively sampling points closer to centroids with higher probability than those farther away. The contribution of each class centroid may also be equally weighted. Each of the C centroids has approximately

$$\frac{N}{2 C}$$

examples associated with it. To account for edge cases where no clusters were identified, a simple random sample may be an appropriate fall back.

In one embodiment, this process can be used to construct the test (e.g., N=150), validation (e.g., N=150), and training sets (e.g., N=1000), for each data practice. For example, in one iteration, the test sets may have 4,376 unique examples, the validation sets may have 4,262 unique examples, and the training sets may have 22,262 unique examples. In total, in one iteration, 30,900 unique data practice policies could be used to train and evaluate classifiers in accordance with the present invention.

Intuitively, the sampling procedure can be thought of as focusing on high-density areas with large amounts of information more likely to be labeled correctly. Points on the edge have a lower probability of being selected: they are assumed to be less likely to be labeled correctly, therefore contributing less useful information. Importance sampling preferably creates a clear separation between the positive and negative classes, in contrast to random sampling.

After constructing the datasets, several model architectures may be used to train the classifier, also referred to herein as a machine learning system. In various embodiments, there can be a classifier for each data type/data practice targeted. Thus, for example, for iOS where data practice labels currently require disclosing whether each of 32 different data types is collected, there can be 32 classifiers, with one classifier for the collection of each data type/for each data practice. Logistic regression may be used as a baseline architecture for the classifiers. Use of more complex classifier architectures, such as multilayer perceptron (MLP), RegLSTM, BERT, ROBERTa, Longformer, Recurrent Neural Networks (RNNs), and Graph Neural Networks (GNNs) may be more gradual. Extensive hyperparameter tuning may be conducted for each model, per data type/practice. Because a separate model is preferably being trained per data type, a final “ensemble” model utilizing a combination of classifier architectures that maximized validation Macro F1 Score may be created.

The classifier models may be trained, for example and in various embodiments, using PyTorch on four NVIDIA Geforce RTX 2080 Ti GPUs. In such a computing architecture, it may take approximately 48 hours to hyperparameter tune and train 32 models across 6 different architectures.

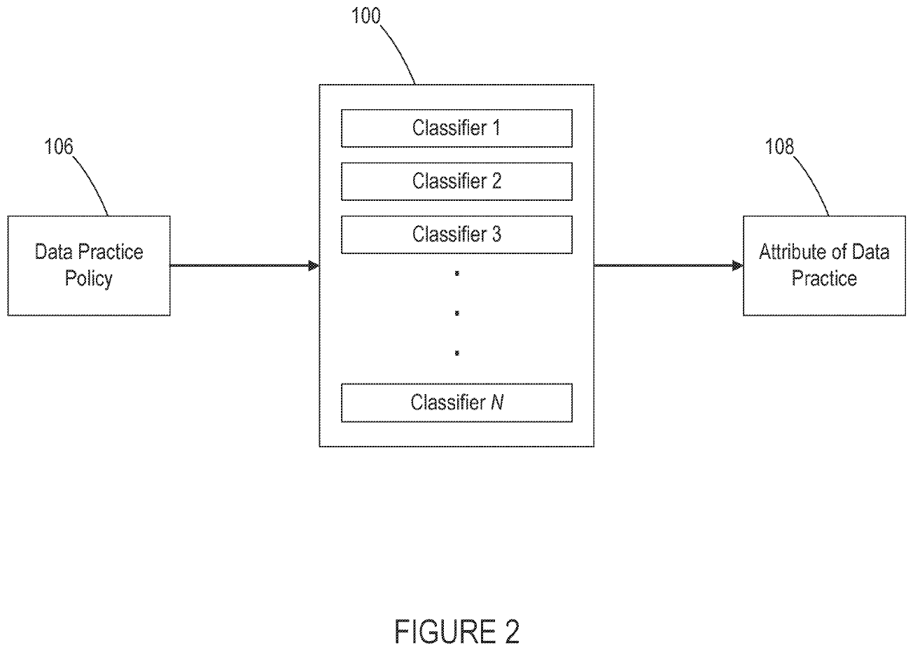

In one embodiment, a final machine learning system in accordance with one aspect of the present invention may be constructed with an ensemble of classifier architectures, with, preferably, one classifier for each privacy label data type (or other data practice), such as shown in FIG. 2. Because the classifier for each data type can be trained separately, the classifier architecture that maximized the Macro F1 score for that data type may be selected. In the case that multiple models have identical Macro F1 scores, the simplest model (e.g., the one with fewer parameters) may be selected for inclusion in the final ensemble. In various aspects, no singular architecture may dominate; however, the baseline architecture may be highly competitive compared to more complex architectures.

Finally, the classifier, illustrated as machine learning system 100, may be evaluated on an unseen set of test data. Overall, in one iteration, an average accuracy of 91.3% and an average Macro F1 score of 91.3% across all classes was achievable. Notably, a Macro F1 score of 100% for the Credit Info data label type, with several other data types being the high-90s may be achieved.

The machine learning system may comprise multiple classifiers as described above.

In that connection, the machine learning system may comprise one or more neural networks, such as, for example, a recurrent neural network(s), a LSTM network(s), a feedforward neural network(s), a convolutional neural network(s), a transformer network(s), and/or an autoencoder(s). A deep neural network comprises an input layer, one or more hidden layers, and an output layer. The input layer receives the input data and each neuron in the input layer can represent one feature of the input data. The hidden layers are between the input and output layers and perform various computations and transformations on the data. The depth of the network refers to the number of hidden layers. The output layer produces the output of the network. The number of neurons in the output layer corresponds to the number of desired output classes or values. Each neuron (or node) in a layer (other than the input layer) receives input from the neurons in the previous layer, applies a weight and bias, and passes the result through an activation function to produce an output. Learned parameters for network, i.e., parameters that are learned through the training, include weights and biases.

The weights are the strength and direction of the influence between neurons. A bias for a node is added to the weighted sum of inputs before applying the activation function.

Activation functions applied to the output of each neuron to introduce non-linearity into the model, allowing it to learn more complex patterns. Common activation functions include ReLU, sigmoid, tanh, and softmax. Hyperparameters are settings or configurations used to control the learning process of a neural network. Unlike model parameters (weights and biases) that are learned during training, hyperparameters are typically set before the training process begins and play a crucial role in determining the performance and efficiency of the model.

Training a neural network involves adjusting the weights of the network to minimize the error between the predicted output and the actual target. To start, the weights of the neural network can be set to small random values and the biases can be set to zero or small random values, for example. The training process can involve three main steps: forward propagation, loss calculation, and backpropagation. In the forward propagation step, an input training data item is fed into the network and is processed through one or more hidden layers, where each neuron (or node) in the network comprises computes a weighted sum of its inputs, applies an activation function, and passes the output to the next layer. The final/output layer produces the output of the network, typically through a softmax or sigmoid function in classification tasks. In the loss calculation step, the loss (or error) using a loss function (e.g., cross-entropy loss for classification, mean squared error for regression). The loss function measures the difference between the network's prediction and the actual target value. The backpropagation step is used to compute the gradients of the loss function with respect to each weight in the network by applying the chain rule of calculus. For the output layer, the gradient of the loss is computed with respect to the output's layer's weights. The gradients are then propagated backward through the network, layer by layer, calculating the gradient of the loss with respect to the weights of each hidden layer. In various other embodiments, auto-differentiation (AD) can be used for computing derivatives in the backward pass. AD, such as used in TensorFlow, PyTorch and JAX, works by breaking down the computation of the function into elementary operations (addition, multiplication, etc.) and applying the chain rule of calculus systematically to these operations to compute gradients of the loss function with respect to learned parameters.

The learned parameters can be updated via, for example, gradient descent or stochastic gradient descent. In gradient descent, the learned parameters are updated for each training data item to minimize the loss. Instead of computing gradients using the entire dataset (which is computationally expensive), stochastic gradient descent (SGD) updates the weights using a single data point or a small batch of data points. Mini-batch SGD uses small batches of training data items (e.g., less than 100 training data items) to update the weights.

Other training approaches that can be used include one-shot and/or multi-shot learning. In one-shot learning, a model learns to recognize a new class (e.g., a new data practice) from just one, or very few, training examples. Techniques for one-shot learning include Siamese networks, triplet networks, matching networks, and prototypical networks. In multi-shot learning, the model is trained using multiple examples (shots) of each class during the training phase.

The machine learning system may comprise, for example, an ensemble of classifiers (e.g., a separate classifier for each of the data practices tested-for for a data label) and/or one or a collection of large language models (LLMs) using, for example, prompt engineering to drive the classifications.

Once trained, the machine learning system 100 may receive an electronic privacy or other data practice policy 106 for a data system, such as a mobile app, and compute a prediction 108 of the applicable data label types/data practices for the data practice policy, where, as explained above, a separate classifier for each possible data type/data practice can be used to determine whether the data type/data practice corresponding to each classifier is applicable (e.g., has a classification score above a threshold value). In various embodiments, the prediction 108 may comprise, for each data practice tested for, (a) the data practice policy is indicative (above some threshold prediction threshold value) of the data system being permitted to engage in the data practice, (b) the data practice policy is indicative (below some threshold prediction threshold value) of the data system not being permitted to engage in the data practice; or (c) the data practice policy not being indicative of either (a) or (b) (e.g., between the thresholds). As mentioned above, for iOS where the collection of 32 different data types has to be disclosed in the labels, there can be 32 classifiers in the machine learning system 100, but in other contexts and settings, where a different number of data types/data practices are tested for, a corresponding number of classifiers could be used. Another embodiment could use, for example, a single classifier and focus on only one particular entry of interest in the data practice labels.

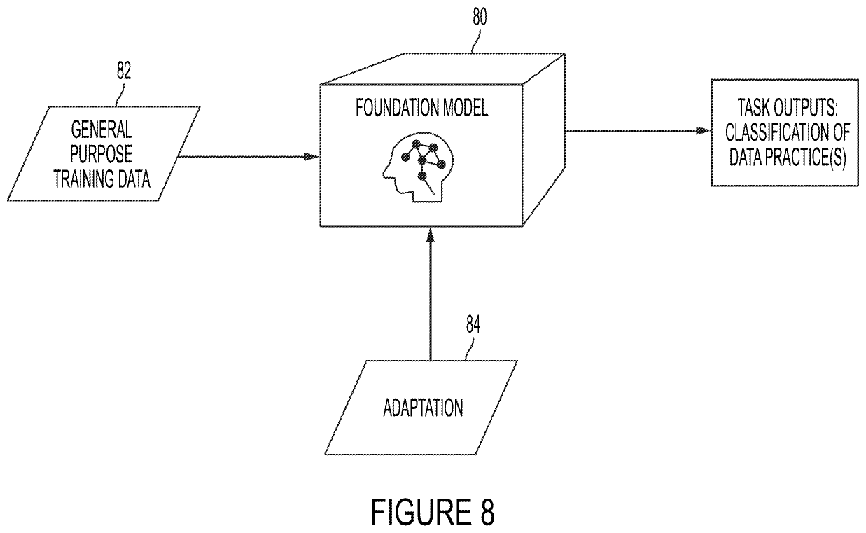

In various embodiments, the classifier or machine learning system could be implemented with a foundation model (running on a computer system or data center). A foundation model is a machine learning or deep learning model that is trained on broad data such that it can be applied across a wide range of use cases. With reference to FIG. 8, the foundation model 80 can comprise a language model such as, for example, Google's BERT or OpenAI's GPT-n series. The foundation model 80 can be trained on broad data 82 (generally using self-supervision at scale) that can be adapted (e.g., fine-tuned) to a wide range of downstream tasks, including to analyze a data practice policy for a data system to determine whether the data system is permitted (or not) to engage in data practices associated a data label for the data system and more generally to predict whether the text of the data practice policy is indicative of other entries covered in the data practice label of a given platform. For a foundation model to effectively generalize, it must acquire rich representations of the training data. As a result, expressive model architectures that efficiently process large-scale data, like transformer architecture, may be used in building the foundation model 80.

The foundation model 80 can be inherently multi-purpose. To use the foundation model 80 for a specific use case, such as analyzing a data practice policy for a data system to determine whether the data system is permitted (or not) to engage in data practices associated a data label for the data system, some form of adaptation 84 can be used. A variety of adaptation methods (e.g., prompt engineering, in-context learning, fine-tuning, LoRA) can be used. Prompt engineering may for instance include providing definitions of data practice label entries as provided for a given platform. This data may also be provided as part of specialized training of the foundation model. The model may be further enhanced with a number of examples such as pairs of data practice policies and corresponding data practice labels. It could also be further enhanced with knowledge of applicable laws and in particular privacy data practice disclosure requirements mandated by applicable laws. For instance, applicable laws (e.g., CCPA) may mandate that if a data system sells someone's data this information should be disclosed in the data practice policy. The absence of such a statement in a data practice policy may under such a regulatory regime be interpreted as an implication that the data system does not engage in this practice-since otherwise it would have to disclose it. The foundation model 80 can be very large, up to trillions of parameters in size, so adapting the entirety of the foundation model 80 can be computationally expensive.

Therefore, in various embodiments, only the last neural layer or only the bias vectors may be adapted to save time and space. Also, in various embodiments, the foundation model 80 can be adapted by adding a task-specific layer (e.g., classification head) to the pre-trained foundation model. In various embodiments, there can be a classification head for each of the data practices covered by the data label, so that each classification head, once trained, makes a classification for each data practice of a data practice label for an input data practice policy for a data system. For fine tuning the model, the adaption data may comprise, in various embodiments, the data practice policies and data practice labels for set of sample data systems.

In one embodiment, the foundation model 80 may comprise a large language model and the adaption may comprise prompt engineering. A user of the foundation model/LLM 80 may provide instructions that can be interpreted and understood by the foundation model/LLM 80 to, based on a data practice policy for the data system and the pre-generated data practice label for the data system, which can be uploaded electronically to the foundation model/LLM 80, identify possible discrepancies in the data practice label for the data system, such as identify data practices that should be listed in the data practice label but that are not listed in the pre-generated data practice label for the data label, and identify data practices that should not be listed in the data practice label but that are listed in the pre-generated data practice label for the data label. The prompt engineering can comprise, for example, providing the foundation model a detailed definition of each data practice that the foundation model is to test for (e.g., classify). In various embodiments, the detailed definition(s) can be the exact definition(s) found in documentation for the data practice label (e.g., iOS App store, Google Play store, etc.). The prompt engineering can also comprise providing the foundation model 80 examples of practice policy text indicative of a data system engaging in (or being permitted to engage in) a particular data practice (e.g., a positive example).

To use the foundation model 80 to assess possible discrepancies in the data practices disclosed in a data label for a data system, a user, from a remote client device (e.g., laptop, mobile computer, etc.) can upload the data privacy policy and the pre-generated data practice label for the data system to the foundation model 80. The user can then provide, from the client device, prompts for the foundation model via input or voice input, for example. The user could submit the prompt in a text input field on an interface for the foundation model 80, which interface can include, for example, a chat window on a website or an app. In some applications, a user might use voice commands, which are converted to text for the foundation model 80 through speech recognition technology of the client device. The user's client device submits the input, which is sent to a server where the foundation model 80 is hosted. This can happen, for example, over the internet using HTTPS (Hypertext Transfer Protocol Secure) to ensure the data is securely transmitted. The server receives the user input and forwards it to the foundation model 80. The foundation model can then process the input text/prompts. In other embodiments, the method may simply have predefined prompts for each data label entry and systematically submit the corresponding prompt(s), whether as a batch request for multiple data label entries or one data label entry at a time. Processing the prompts may involve several steps, including: tokenization, where the input text/prompt is broken down into smaller units called tokens; encoding, where the tokens are converted into numerical representations that the model can understand; inference, where the model generates a response based on the input tokens and its pre-trained knowledge; and decoding, where the numerical output is converted back into human-readable text. The foundation model's response can be formatted into a coherent text message, such as identification of any discrepancies between the pre-generated data label for the data system and the data practices that the foundation model 80 identified that the data system is permitted to engage it. Additionally or alternatively, the response could indicate, for each tested-for data practice attribute covered in the data label, whether, based on the data practice policy for the data system, the data practice policy for the data system is indicative of the data system having to have a particular entry in its data practice label—or not having a particular entry in its data practice label or neither. In some cases the prediction could even indicate that the data practice policy seems to be inconsistent. In some embodiments, the response from the foundation model 80 can be sent back to the user's client device (e.g., via the internet or some other communication channel), where it can be displayed or downloaded, for example. Interactions between the user interface and the foundation model can be facilitated by APIs, for example. The foundation model 80 can run on a server system (with many networked servers), and the server system can include, in addition to the servers on which the foundation model 80 runs, a web server or other backend servers for providing the user interface for the user's client device. Alternatively, the foundation model could also possibly run on the user's personal device.

In one embodiment aimed at analyzing a collection of data systems (e.g. mobile apps) on a given platform, once the machine learning system 100 has been trained, the machine learning system 100 may be used to predict the applicable entries for the data practice labels of those data systems (e.g., mobile apps) not included in the training process. For each data system, each data label entry prediction (based on the data system's data practice policy) may be compared with the actual data practice entry to identify potential discrepancies between the predictions and the data practices disclosed in the data practice label. In one example, after removing training data, a set of data practice policies corresponding to 61,596 iOS apps remained. The following discrepancy analysis may be used for those remaining apps.

First a potential compliance issue may be characterized. In this particular instance, we assume that one is only concerned with the possible collection of 32 different data types covered in the iOS privacy labels. For an arbitrary app, let P be the set of data practices of the app as predicted by the application of the machine learning system (machine learning classifier(s)) to its data practice policy, and let L be the set of data practices of the app as disclosed in its data practice label. Let D represent the set of 32 data collection types/data practices captured by iOS data practice labels, and let d∈ D be a single data collection type/data practice. Let \hat{d} denote a predicted data collection type/data practice by applying the corresponding classifier to the data practice policy. By definition, P⊆D and L⊆D since we are only considering the 32 data collection practices that need to be disclosed in iOS data practice labels.

The first type of potential compliance issue for an app is an incomplete data practice policy (also referred to herein as an “incomplete policy”):

∃ d ∈ D, such that (\hat{d}∉P)Λ(d∈L)

Intuitively, an incomplete policy means that a data practice policy does not disclose the collection of a data type/data practice for the app, while the developer of the data system reported that particular data collection practice in the data practice label.

The second type of potential compliance issue is an incomplete data practice label (also referred to herein as an “incomplete label”):

∃ d ∈ D, such that (\hat{d}∈P)Λ(d∉L)

Intuitively, an incomplete label is when collection of a data type/data practice is disclosed within a data practice policy for an app, but not within the data practice label for the app.

If one focuses only on data collection entries in a data label such as the 32 data collection entries in iOS data labels, potential compliance issues may be on a per data type basis. This means that the total number of potential compliance issues per app may be capped at D (one per data type/data practice), such as 32 for an embodiment based on iOS privacy label data types. Some types of potential compliance issues may be viewed as more important than others, which in turn may result in different treatment (e.g., selecting which data system to subject to a more in-depth analysis). In one embodiment one could decide that an “incomplete policy” issue is more likely to be indicative of a potential compliance issue than an “incomplete label” issue given that in some instances a data practice policy may apply to multiple data systems. In other words, not all data systems to which a particular data practice policy applies necessarily need to disclose in their data labels every data practice attribute disclosed in their data practice policy.

Further, in some embodiments, only potential compliance issues with high probability may be flagged. The probability that a policy collects a particular data type/engages in a particular data practice (i.e., p_{\hat{d}∈P}) may be formulated as a binary classification problem for each data type/data practice, p_{d∈P}=1−p_{\hat{d}∈P}. For example, most policies have a high probability of collecting the Name data type or a high probability of not collecting Name—in other words predictions for this data practice may tend to be very accurate—when using some classifiers. However, when using some classifiers, one may determine that predicting whether a mobile app collects the Precise Location of its user may be less accurate (e.g. probability close to 50%). Under such conditions, in some embodiments, only the following may be considered:

(\hat{d}∉P)⇔(p_{\hat{d}∈P}<0.25)

(\hat{d}∈P)=(p_{\hat{d}∈P}>0.75)

In such embodiments, only predictions with high probability may be considered; otherwise, the prediction may be classified as “Inconclusive.” Specific thresholds used to make this determination may vary based on the performance of the specific classifiers and may also vary based on other considerations (e.g., how sensitive the particular compliance issue/data practice might be, how popular the particular data system might be, whether the data system is targeted towards children, etc.) In some embodiments where one is concerned with the overall state of compliance on a given platform, compliance issues may be broken down by data practice. The percentage for each data type/data practice, d∈D, may be the total number of incomplete policies for d divided by the total number of apps where d∈L. For example, in one iteration, 27.7% of apps have data practice policies that do not declare collection of Name, even when their data practice labels assert that they do.

Similarly, the rate of incomplete labels may be broken down by data type/data practice. The percentage for each data type/data practice, d∈D, may be the total number of incomplete labels for d divided by the total number of apps where d∉L. For example, in one iteration, 42.9% of apps were found to have data practice labels that did not declare collection of Name, even when their data practice policies asserted that they did.

Of note in this particular instance were incomplete policies within financial disclosures. In one iteration it was determined that 62.4% of apps declaring the Credit Info data type and 63.9% of apps declaring the Other Financial Info data type on their privacy labels have incomplete privacy policies. This particular set of potential compliance issues could be a violation of the Gramm-Leach-Bliley Act.

Potential compliance issues may be shown as a distribution and cumulative distribution. For example, in this one instance, incomplete policies were found to be less common than incomplete labels, with, in one iteration, apps having an average of 0.62 incomplete policy discrepancies and 4.70 incomplete label discrepancies. When looking at the combination of incomplete policy and label errors, apps had 5.32 potential compliance issues on average.

When reviewing a cumulative distribution function (CDF) for each data type/data practice, in one iteration, 26.8% of apps had at least one incomplete policy discrepancy and 85.7% of apps had at least one incomplete label discrepancy. When analyzing both incomplete policies and labels, 88.0% of apps had at least one discrepancy.

App rating and number of potential compliance issues may also be compared. For example, for incomplete policy compliance issues, a weak, significant positive correlation (r=0.04, p<0.05) between app rating and number of incomplete policy discrepancies was found. That is, as the number of incomplete policy discrepancies increase, the app rating tended to increase.

While the previous result may be surprising, the relationship between app rating and incomplete label discrepancies may be more expected: a weak, significant negative correlation (r=−0.011, p<0.05) was found. That is, as the number of incomplete label discrepancies increase, the app rating tended to decrease.

In such an analysis of data systems on a gibven platform, the incidence of discrepancies between popular and other data systems may be compared. Other data systems (i.e. unpopular apps in this particular instance), tended to have a statistically significantly higher number of incomplete label discrepancies, on average, than popular apps (p<0.05).

Consequently, when looking across all discrepancies, other apps also had a higher number of discrepancies, on average, than popular apps (p<0.05). In this particular instance, there was no significant difference between the incidence of incomplete policy discrepancies between popular and other apps (p>0.05).

In this particular instance, it may be concluded, therefore, that popular apps, on average, have fewer discrepancies than their counterparts. As popular apps represent apps likely to be on user's devices, this trend was deemed reassuring; however, the incidence of discrepancies among popular apps was found to still be high, at an average of 5.15 discrepancies per app.

As discussed in detail above, data practice labels have been proposed as usable mechanisms to help users better understand salient data practices found within data practice policies (such as privacy policies). However, developer-created data practice labels are not always perfectly accurate. In particular, in the case of a study of iOS apps, incomplete label discrepancies were found to generally be more common than incomplete policy discrepancies. This could likely be a byproduct of data practice policies being written to be more general and permissive than data practice labels because data practice policies are more likely to be written by lawyers, whereas data practice labels are more likely to be created by users/developers. Additionally, one data practice policy may apply to multiple types of data systems owned by the same individual or entity (i.e., a company's mobile application and website), which could explain why they may disclose data practices that an individual data system (e.g., a mobile app) may not engage in. Data practice labels, on the other hand, are typically created for individual data systems (e.g., an individual mobile app or website), meaning the data system is more likely to only disclose the data practices that this particular data system actually engages in. Accordingly, incomplete data practice policies may be deemed more likely to be indicative of compliance issues than incomplete data practice labels.

The present invention can be used, in various embodiments, to compare disclosures within data practice policies for a data system to those in data practice labels for the data system. Specifically, in various embodiments, using state of the art natural language processing/machine learning techniques, the present invention can be used to predict data labels for data systems from the text of data practice policies of the data systems and compare the predicted data practices with those reported by the owner/developer of the data system.

The present invention can, therefore, in various aspects, enable a detailed analysis of available data systems and be used to identify potential discrepancies between disclosures made in data practice policies and in data practice labels. This invention can be used to support compliance analysis, where discrepancies between policy disclosures and label disclosures are used as signals indicative of potential compliance issues as well as possibly other problems. This analysis can also benefit from the include of additional signals aimed at determing whether further analysis is warranted. Such signals may include the sensitivity of the particular data practices found to be the source of potential discrepancies. They may include the popularity of the particular data system or whether the data system is targeted towards particular populations of data subjects (e.g. populations at risk such as children, the elderly, etc.). They may also include the historic record of the publisher/developer behind a given data system, whether the data practices involve sharing sensitive data with foreign actors, and much more.

Although this illustrative embodiment has been generally described herein with respect to mobile applications (e.g., apps for a mobile device) and privacy policies, it should be understood that the invention can apply in other embodiments and contexts to any data system subject to any type of data practice policy, such as policies related to use, collection, processing, sharing, selling, retention, transmission and storage of data collected by the data system. Such data systems include, but are not limited to mobile apps, IoT devices, websites, credit cards or other digital payment platforms, electronic devices (e.g., cars, cameras, games, etc.) that capture data, etc.

Further, under many different regulatory regimes, organizations are required to disclose their data practices. This often takes the form of a “privacy policy” or “privacy notice”. Such a policy or notice may be in the form of a flat document or may be organized as a multi-layered document such as a document that allows users to navigate the text through hyperlinks. By extension, the use of the term “data practice policy” herein refers these and other types of disclosure statements, whether purely text-based or using other modes of communication including but not limited to audio, graphics, or video. In addition, data practice policy, as used herein, can also include other documents or sources of information that may include disclosures about the data practices a data system may engage in. Such data practice policy can include, but is not limited to, a privacy policy, a data usage policy, a terms of service policy, a terms of use policy, a set terms and conditions, a governmental regulation or legislation, a plurality of policy resources including, but not limited to, the policies listed herein, or any other equivalent document where an organization many provide information about its data practices as an additional disclosure beyond those made in a privacy policy.

This may also include additional documents detailing an organizations security practices or additional rights, including but not necessarily limited to data rights, provided to consumers.

Additionally, as used herein, data practices are defined as the way in which a data system collects and handles data. This includes, but is not limited to, what data the data system collects, for what purpose the data are being collected, with whom that data might be shared and for what purpose, for how long the data are retained, where the data are retained, in what form the data are retained (e.g., raw data, featured data, (pseudo)anonymized data, anonymized data, anonymous data, reidentifiable data, etc.), etc. Data practices also include what rights the users of data systems (i.e., the subject of the data) might be given such as, but not limited to, the right to opt-in or opt-out of the collection and/or processing of some data, the right to opt-in or opt-out of collection and processing for certain purposes only, the right to delete one's data, the right to review one's data, the right to correct one's data if it is erroneous, the right to contest the accuracy of some data, etc. Further, data practices can also include details about the security practices associated with the collection, storing, processing, and transmission of data such as, but not limited to, whether data are encrypted and whether security practices extend to the systems used to store, process and transmit data. For example, this may include determining whether organization(s) responsible for the collection, processing or transmission of data adhere to best practices and which best practices they follow (e.g., whether they follow a particular standard and/or have been certified).

Further, as used herein, a data practice label refers to a collection of entries or fields summarizing key data practices or data types of a data system, such as those data practices people are known to care about or data practices that organizations are expected or required to report, such as the 32 entries in iOS data labels dealing with the collection of sensitive data. Note that iOS labels cover other practices beyond just collection and that other labels such as the Google Play Store safety labels, Amazon app store labels, IoT Privacy Infrastructure labels and other labels cover a number of other data practice attributes. The invention detailed here can readily be extended to build classifiers to predict entries in these labels as well.

Although discussed herein in reference to Apple's decision to require data practice labels for the applications in the Apple App Store, other digital platforms, such as the Google Play Store, also require data practice labels corresponding to data practice policies on available applications. Additionally, it is anticipated that the use of data practice labels will become more prevalent over time. This may occur via laws or regulations passed by a governmental entity, or it may be initiated by private business entities.

Further, as discussed in detail above, data practice labels are currently generated by application developers for each individual data system, either manually or with the assistance of a data practice label generation tool. Typically, application developers (or developers of various other data systems) are tasked with generating the appropriate data practice label for a particular data system. The human-interference aspect of generating data practice labels can introduce discrepancies between the data practice policy and the data practice label. Such a discrepancy may result in a compliance issue with the requisite digital platform guidelines (such as the App Store's policy) or, eventually, with a law or regulation. For example, a broadly written data practice policy may not be fully captured by a data practice label. In other words, a lawyer who has written a data practice policy may have been risk-averse, such that the data practice policy was drafted to cover a broad range of user activity on the data system. The developer who wrote the data practice label, on the other hand, may have understated the breadth of the data practice policy to avoid the stigmas associated with various data practices. Identifying this discrepancy would alert the owner of the data system to review the data practice label and the corresponding data practice policy to ensure that the data label accurately reflects the full scope of the policy.

Further, potential discrepancies between data practice policy disclosures and data labels may not always correspond to actual discrepancies. For instance, a data practice policy may apply to more than one data system (e.g., several mobile applications, or a mobile application and a website, or a mobile application and a corresponding Internet of Things system with which the mobile application may interact). As such disclosures made in data practice policies may be broader than those made in the data label of a particular system.

Additionally, data practice policies may be written to allow for practices that a data system is not currently engaging in. Attorneys may for instance decide to err on the safe side in the disclosures they make in a data practice policy. As a result, not all discrepancies between predictions made based on the text of data practice policies and data labels are necessarily indicative of issues such as compliance issues. Different discrepancies may in fact benefit from being treated differently, such as using discrepancies as possible signals of compliance issues or potential triggers for a more in-depth analysis. For instance, a situation where a data practice policy allows for a given data practice but a data label denies engaging in that practice, the discrepancy may simply indicate that the data practice policy applies to other data systems beyond just the one being considered, or the attorneys who wrote the data practice policy may have decided to err on the safe side and include text that allows the system to engage in some practices it may not actually be engaging in. In contrast, a data label that positively discloses that a data system engages in a given practice while the corresponding data practice policy explicitly denies engaging in that practice is more likely to be indicative of a compliance issue, though even in such a situation a more in-depth analysis will often be warranted. This is an example where additional signals could be used to determine whether a true compliance issue is likely present. An example of such an additional signal could be the result of dynamic code analysis to determine for instance whether the data system collects some particular data or shares some particular data with third party. Another example of an additional signal could be the result of an analysis of the code (“static code analysis”) to determine whether the code seems to be engaging in a given practice.

Accordingly, the present invention, in various embodiments, enables an analysis of data systems and the development of a machine learning system that can accurately predict data practices from data practice policies associated with the data system. This machine learning system can be used to conduct compliance analyses in order to identify discrepancies between the data practice policy for a data system and its data practice label.

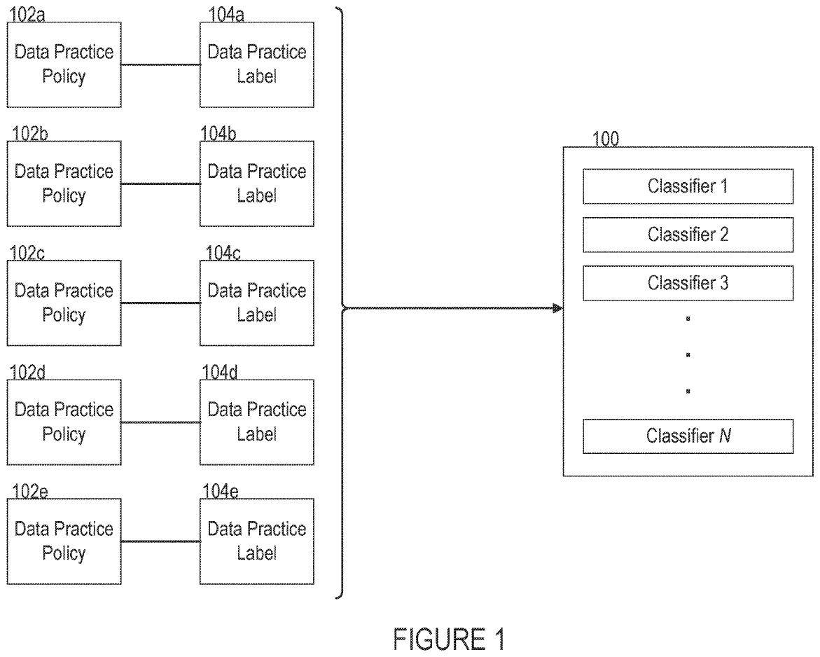

Referring to FIG. 1, and as described generally above, a classifier, as illustrated by machine learning system 100 can be trained by a computer system through machine learning using a training data set that comprises a data practice policy and a data practice label for plurality of sample/training data systems. The training data set can comprise a data practice policy 102a-e and a corresponding data practice label 104a-e for each of the sample data systems. The data practice labels 104a-e should summarize the data practices of the data system as provided by the data practice disclosures made in the data practice policy 102. A data practice label 104 can include N potential data practices. For example, the number of data practices may correspond to the number of data types, as discussed in further detail above. As such, N data practices may correspond to 32 data types in the case of iOS apps.

Of course, in other embodiments, there could be a different number of data practices/data types tested for.

In various embodiments of the present invention, the machine learning system 100 may comprise multiple classifiers, wherein each of the multiple classifiers is trained to predict whether one of the N data practices or data practice attributes covered in a data practice label applies to the data system. In various embodiments, the machine learning system comprises N (>=1) classifiers—one for each data practice tested for—where each of the N classifiers may be trained, through machine learning, to predict whether the data practice policy for the data system is indicative of a respective, tested-for data practice or data practice attribute associated with the data practice label. Training of the machine learning system 100 can occur using the methods discussed in further detail above, or by any other available methods known to train a machine learning system. Training may also include using foundation models in combination with appropriate prompts and/or in combination with specialized training design to enhance the accuracy of predictions for a particular type of data practice label (e.g., a data practice label used/mandated by a given platform).

In various embodiments, the machine learning system 100 may be trained using importance sampling techniques, as discussed in more detail above. Labeling policies by hand is time consuming. Instead, it is more efficient to use a probabilistic approach. For example, importance sampling, as described herein, can use a large quantity of previously generated data practice labels 102a-eand the data practice policies 104a-e corresponding to the data practice labels 102a-e. It may be assumed that the data practice labels 102a-e of the sample data systems are an accurate reflection of the corresponding data practice policies 104a-e. In turn, if a subset of the sample data systems have data practice policies 104a-e that are generally similar, and each of the sample data systems in that subset of data systems are labeled in a similar way (i.e., each data systems' data practice label indicates includes a particular data practice), then it is reasonable to assume that a new data practice policy that is relatively similar to the data practice policies of the subset of the sample data systems should also include the common data practices on its respective data practice label. This importance sampling technique can be used to train the machine learning system 100 to predict the data practices 108 of data systems accurately based on the data system's data practice policy 106, as shown in FIG. 2.

FIG. 2 illustrates an inference stage for the machine learning system 100 after machine learning system is trained to generate data practice predictions 108. Once trained, the machine learning system 100 can be used to generate a prediction 108 of whether the target data system performs each of the N tested-for data practices. The data practice policy 106 of the target data system can be input into the machine learning system 100 and the machine learning system can output a data practice prediction 108. In various embodiments, the data practice prediction 108 can comprise one of three alternatives: (a) the data practice policy is indicative of the data system being permitted to engage in the data practice; (b) the data practice policy is indicative of the data system not being permitted to engage in the data practice; or (c) the data practice policy not being indicative of either (a) or (b).

For example, in various embodiments, each test-for data practice for the data label prediction corresponds to an individual classifier of the N classifiers in the machine learning system 100. Further, the N classifiers of the machine learning system 100 can have non-homogenous model architectures. That is, not all of the classifiers need to have the same machine learning architecture, although some of them can have the same machine learning architectures (although with different parameters, hyperparameters, and output classifications). That is, two or more classifiers of the N classifiers in the machine learning system 100 can have the same model architecture, or each classifier of the N classifiers in the machine learning system 100 can have a different model architecture. In various embodiments, each classifier of the N classifiers in the machine learning system 100 can comprise any of the model types described in more detail above. For example, at least one classifier of the N classifiers can comprise a machine learning architecture model selected from the group consisting of a logistic regression model, a large language model, a transformer-based model, and a multilayer perceptron model, or any combination thereof.

In further reference to FIG. 2, the data practice policy 106 is input to the machine learning system 100, which can then generate a prediction of whether the target data system performs each of the N data practices. This output may take the form of a data practice predication 108. The generated data practice prediction 108 can be indicative of the predicted data practices that the target data system engages (or does not engage in for negative data practices) in and can be used to create a data label for the data system or to compare to an existing, predetermined data label for the data system to identify discrepancies. On the other hand, data practice policies may be ambiguous and may not specify whether a data system engages in a data practice or not. Some data practice policies may, however, specifically deny engaging in a given data practice. Such a denial can be a strong indication of a potential compliance issue if the corresponding data practice in the existing data practice label indicates the opposite. Accordingly, the generated data practice predication 108 can also be indicative of whether the data system does not engage in any of the N data practices.

The data practice prediction 108 output from the machine learning system 100 may take the form of a predicted data label, a list of the predicted data practices, or a human-language summary of the data practice policy 106. In various embodiments, the machine learning system 100 may cooperate with a programmed computer system to summarize the predicted data practices output from the machine learning system 100 in a manner that is easily digestible for the end user of the data system to understand the relevant data practices disclosed in the data practice policy prior to engaging with the data system. As discussed above, this process/analysis is more robust than automatically generating a data label based on developer input (i.e., via a questionnaire). Instead, the present invention can generate a data practice prediction 108 based on a data practice policy 106 in comparison to other policies and data labels.

As explained herein, a particular data practice label regime might test for, or cover, multiple data practices (e.g., 32 data types in the case of iOS). The data practice label for a particular data system (e.g., mobile app) can identify all of the data practices covered by the data practice label regime that the data system employs or uses. It can also identify all of the coverable data practices that the data system does not use. For example, using an example the 32 iOS data types covered by iOS data labels, the developer-created data label for a particular mobile app may indicate that the mobile app collects or uses the following data types: contact info; financial information; location; browsing history; and purchases. The machine learning system, once trained and through its analysis of the data practice policy (e.g., privacy policy) for the data system, might predict that the data system also collects search history data and health/fitness data but does not collect or use financial information.

Thus, the discrepancy in this example that can be discovered by the machine learning system is that search history data and health/fitness data should be added to the data practice label for the data system, but that financial information possibly should be removed from the data practice label. In different contexts, the data practice label regime tests for, or covers, different data practices, and the machine learning system can test for each data practice covered by a particular data practice label regime, as the case may be, to predict which data practices covered by the data practice label should and/or should not be disclosed in the data practice label for a particular data system.

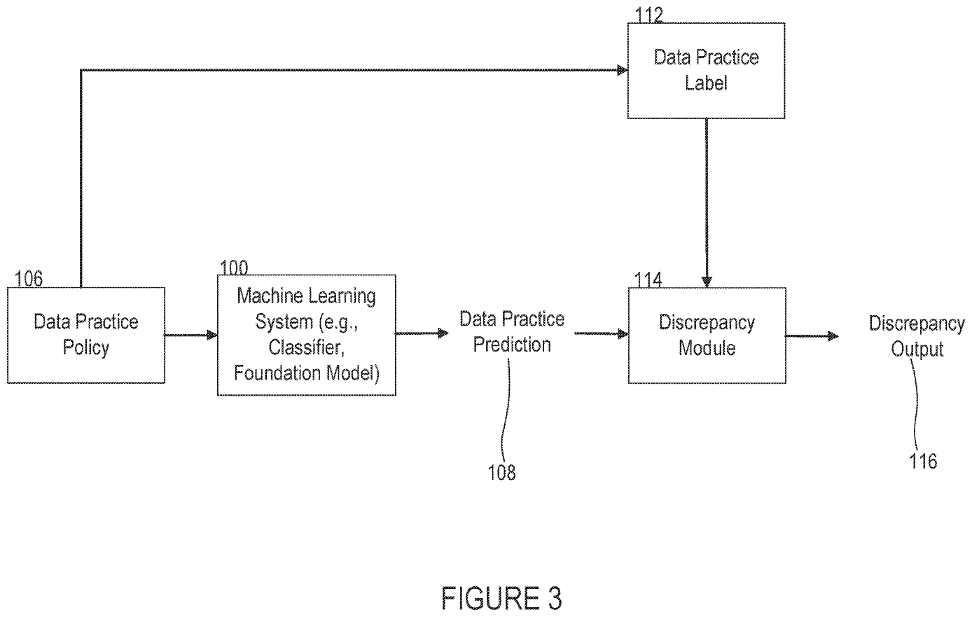

Referring now to FIG. 3, in various embodiments, after generating the data practice prediction 108 based on the data practice policy 106 as described in reference to FIG. 2, the data practice prediction 108 is compared, by a discrepancy module 1114, to a pre-determined or otherwise existing data practice label 112 for the target data system to identify any discrepancies between the data practice prediction 108 and the pre-determined data practice label 112. Specifically, the output of the machine learning system 100, i.e., the data practice prediction 108, can be input into the discrepancy module 114, which can be embodied as a software program running on a programmed computer system, which programs the computer system to identify the discrepancies. The user-determined data practice label 112, which can be generated by an individual or entity associated with the target data system to reflect the data practice policy 106 prior to the discrepancy analysis, is also input into the discrepancy module 114. The discrepancy module 114 can compare the data practice prediction 108 to the user-determined data practice label 112 to identify discrepancies 116 between the data practice prediction 108 and the user-determined data practice label 112.

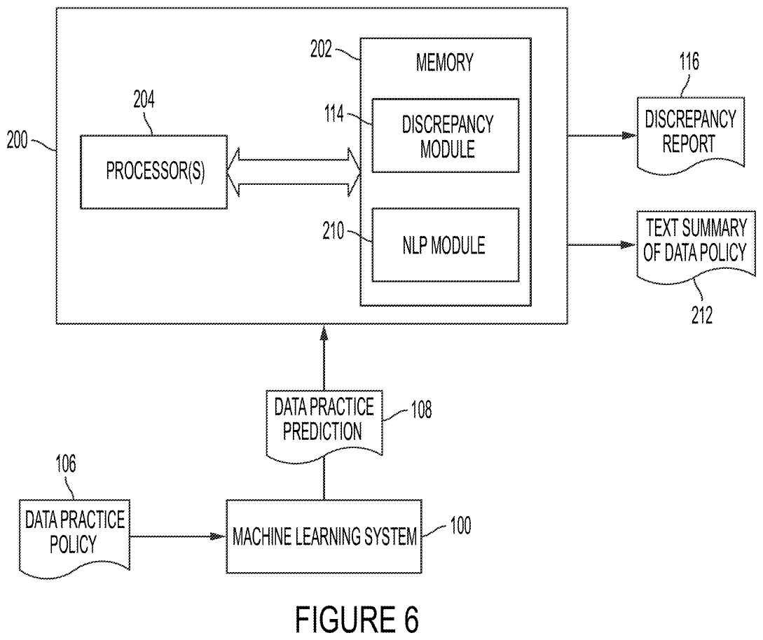

As shown in FIG. 6, the software for the module 114 may be stored in memory 202 of the computer system 200 and executed by a processor(s) 204 of the computer system. The memory 202 may comprise non-volatile (e.g., ROM) or volatile memory (e.g., RAM). When in use, the software of the module 114 can be loaded from non-volatile memory to the computer system's volatile memory for execution by the processor(s) 204.

The example of FIG. 6 also shows that the computer's memory 202 may comprise a natural language processing (NLP) module 210 for creating a textual summary 212 of the data practices of the target data system based on output of the machine learning system 100, e.g., the data practice prediction 108. In other embodiments, a large language model (LLM) could be used to generate the text summary 212 from the data practice prediction 108.

Additionally, the identification of discrepancies 116 between the data practice policy 106 and the user-determined data practice label 112 may be extended to inconsistencies beyond the data practice policy 106 and the user-determined data practice label 112. For example, various embodiments of the present invention may also detect inconsistencies between regulations and the data practices of the data system. The regulations may be established by a governmental agency, or the regulation may be a guideline established by a digital platform provider, for example. Regardless of how the regulation is established, a system in accordance with various embodiments of the present application may be used to identify discrepancies between the regulation and the data practices of the data system.

The identified discrepancies may be output from the discrepancy module in the form of a discrepancy output 116. The discrepancy output may take a variety of forms. For example, the discrepancy output 116 may include flagging the identified discrepancies. Flagging the identified discrepancies may include, but is not limited to, marking a data system as inconsistent in an electronic file stored in a database, memory, or other storage device, listing all of the N data practices and identifying whether the user-determined data practice label 112 and the data practice prediction 108 identified the each of the predicted data practices as applicable; or transmitting an electronic alert to another system, where the alert comprises a message comprising the identified discrepancies. The other system could be, for example, a data platform where a user could access or download the data system and/or an owner or responsible party for the data system. To that end, the flagging of the possible discrepancy can comprise identifying the given data practice and the type of discrepancy (e.g., incomplete data practice policy or incomplete data practice label) that has been identified. Flagging the possible discrepancy can also comprise identifying at least one relevant segment of text in the data practice policy that led the classifier to identify the possible discrepancy for the given data practice, with the identified text segment (or an excerpt thereof) being included in the report generated from the discrepancy analysis.

Because the discrepancies may be indicative of non-compliance with a guideline or regulation, the present invention may also transmit the identified discrepancies between the data practice prediction 108 and the user-determined data practice label 112 to a digital platform provider or other entity responsible for digital platform (e.g., Apple, which is responsible for the Apple IOS App Store, or Google, which is responsible for the Google Play Store) or regulator. For example, the discrepancy output may be transmitted to a digital platform provider, which can include, but is not limited to, an application store operator, a software distributor, or a system distributor. Further, the discrepancy output may be transmitted to a regulator and/or a legislative entity responsible for managing compliance with any relevant data practice laws or regulations. Additionally, the discrepancy output may be transmitted to the owner or operator of the data system, which may include the business entity that owns the data system, a developer of the data system, or any similarly situated individual or entity. Transmitting the discrepancy output to third parties can also warn end users that the data practices of the data system are not accurate represented by the provided data practice label, for example. Similarly, transmitting the discrepancy output can also notify a developer or lawyer associated with the data system that either the data practice policy or the data practice label should be updated to ensure that the data practice label is accurate and compliant.

In various alternative embodiments of the present invention, the input to the machine learning system 100 may also include static software code for the data system. In such embodiments, the machine learning 100 can determine the data practices prediction 108 based on the software code for the data system independent of, or in addition to, the data practice policy for the data system. Static software code, for use in static analyses, can include, for example, having the machine learning system 100 make its classifications based on lines of the code for the data system in the native coding language or via text file.

As such, the machine learning system 100 can also be trained to make predictions using static software code as an input in addition to, or independent of, the data practice policy. In such embodiments, the training dataset of sample data systems can be grouped, at least in part, based on the static software code for each of the sample data systems.

Importance sampling techniques, as described above, can be used to generate a probability that static software code comprising characteristics of the static software code for the grouped subset of the sample data systems has the same data practices as the respective data practices provided on the data practice labels of the grouped subset of sample data systems.

In various alternative embodiments of the present invention, the input to the machine learning system 100 may comprise data reflecting dynamic operation or behavior of the data system. In such embodiments, the machine learning system 100 can determine the data practices prediction 108 based on such dynamic operation or behavior data of the data system independent of, or in addition to, the data practice policy of the data system. For example, dynamic analysis may involve operating or simulating the data system to identify how the application operates, and collecting data from such operation or simulation (e.g., transaction logs, event logs, task queues, process flow logs, branching metrics, data captured, sent or stored by the data system, etc.), such that the actual operation of the data system can be compared to the user-determined data practice label 112. This may be used to determine the data practices engaged in (or not engaged in) by the data system as the dynamic operation or behavior of the data system can be determined, for example, based on data sent to a third party from the target data system while the target data system is operating. Such digital analysis may be used to identify discrepancies between the actual use of the data and the user-determined data label 112.

Additionally, the machine learning system 100 can also be trained to make its predictions based dynamic operations or behaviors of the data system in addition to, or independent of, its data practice policies. In such embodiments, the training dataset of sample data systems can be grouped based on the dynamic operation or behavior of each of the sample data systems. Importance sampling techniques, as described above, can be used to generate a probability that dynamic operations or behaviors comprising characteristics of the dynamic operations or behaviors for the grouped subset of the sample data systems has the same data practices as the respective data practices provided on the data practice labels of the grouped subset of sample data systems.

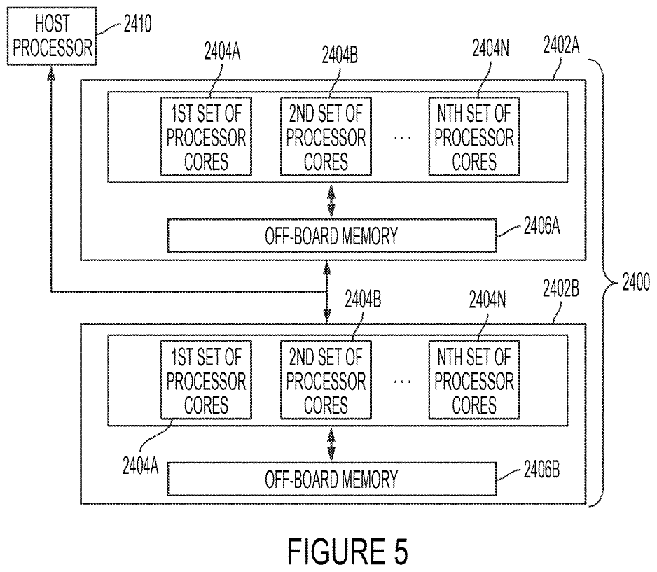

FIG. 5 is a diagram of a computer system computer system 2400 that could be used to implement the embodiments described above, such as to train the machine learning system 100. The illustrated computer system 2400 comprises multiple processor units 2402A-B that each comprises, in the illustrated embodiment, multiple (N) sets of processor cores 2404A-N. Each processor unit 2402A-B may comprise onboard memory (ROM or RAM) (not shown) and off-board memory 2406A-B. The onboard memory may comprise primary, volatile, and/or non-volatile storage (e.g., storage directly accessible by the processor cores 2404A-N). The off-board memory 2406A-B may comprise secondary, non-volatile storage (e.g., storage that is not directly accessible by the processor cores 2404A-N), such as ROM, HDDs, SSD, flash, etc. The processor cores 2404A-N may be CPU cores, GPU cores and/or AI accelerator cores. GPU cores operate in parallel (e.g., a general-purpose GPU (GPGPU) pipeline) and, hence, can typically process data more efficiently that a collection of CPU cores, but all the cores of a GPU execute the same code at one time. AI accelerators are a class of microprocessor designed to accelerate artificial neural networks. They typically are employed as a co-processor in a device with a host processor 2410 as well. An AI accelerator typically has tens of thousands of matrix multiplier units that operate at lower precision than a CPU core, such as 8-bit precision in an AI accelerator versus 64-bit precision in a CPU core.

In various embodiments, the different processor cores 2404 may train the machine learning system 100. One or more host processors 2410 may coordinate and control the processor units 2402A-B.

In other embodiments, the system 2400 could be implemented with one processor unit 2402. In embodiments where there are multiple processor units, the processor units could be co-located or distributed. For example, the processor units 2402 may be interconnected by data networks, such as a LAN, WAN, the Internet, etc., using suitable wired and/or wireless data communication links. Data may be shared between the various processing units 2402 using suitable data links, such as data buses (preferably high-speed data buses) or network links (e.g., Ethernet).

The software for the various machine learning systems and software modules described herein and other computer functions described herein may be implemented in computer software using any suitable computer programming language, such as .NET, C, C++, or Python, and using conventional, functional, or object-oriented techniques. For example, the various machine learning systems may be implemented with software modules stored or otherwise maintained in computer readable media, e.g., RAM, ROM, secondary storage, etc. One or more processing cores (e.g., CPU or GPU cores) of the machine learning system may then execute the software modules to implement the function of the respective machine learning system (e.g., student, coach, etc.). Programming languages for computer software and other computer-implemented instructions may be translated into machine language by a compiler or an assembler before execution and/or may be translated directly at run time by an interpreter. Examples of assembly languages include ARM, MIPS, and x86; examples of high-level languages include Ada, BASIC, C, C++, C#, COBOL, Fortran, Java, Lisp, Pascal, Object Pascal, Haskell, ML; and examples of scripting languages include Bourne script, JavaScript, Python, Ruby, Lua, PHP, and Perl.

Unless specifically stated otherwise as apparent from the foregoing disclosure, it is appreciated that, throughout the foregoing disclosure, discussions using terms such as “processing,” “computing,” “calculating,” “determining,” or the like, refer to the action and processes of a computer system e.g., the computer system 2400 of FIG. 5), or similar electronic computing device, that manipulates and transforms data represented as physical (electronic) quantities within the computer system's registers and memories into other data similarly represented as physical quantities within the computer system memories or registers or other such information storage, transmission or display devices.

Various aspects of the subject matter described herein are set out in the following aspects, implementations, and/or examples, which can be interchangeably combined together in various combinations:

In one general aspect, therefore, the present invention is directed to computer systems and computer-implemented methods for identifying potential discrepancies between data practice disclosures made in a data practice policy and a data practice label for a data system. The data system could be, for example, a mobile application, an IoT device, a website, or an electronic data that captures data. The data practice policy for the data system could be a privacy policy, text of a government regulation, an end user agreement, terms and conditions for the data system, and/or a terms-of-use statement for the data system. In one embodiment, the method comprises the step of applying to the data practice policy a classifier for a given data practice covered by the data practice label to generate a prediction of whether the data practice policy discloses an attribute of the given (positive or negative) data practice for the data system. The classifier can run on a computer system. The method also comprises the step of comparing, by the computer system, the prediction for the given data practice with an entry in the data practice label for the data system to identify a possible discrepancy between the prediction and the data practice label. An embodiment of a system according to the present invention comprises a computer system and a classifier running on the computer system. The classifier is trained to generate a prediction of whether the data practice policy discloses the attribute of the given data practice (positive or negative) covered by the data practice label for the data system. And the computer system is configured to identify a possible discrepancy between the prediction and the data practice label based on a comparison of the prediction for the given data practice with an entry in the data practice label for the data system.

In various implementations, the classifier is trained to make predictions via machine learning. Also, there can be N>1 data practices covered by the data practice label, and the step of applying to the data practice policy the classifier can comprise applying to the data practice policy the classifier for each of the N data practices covered by the data practice label to generate a prediction of whether the data practice policy is indicative of the data system discloses attribute for each of the N data practices (positive or negative). Also, the step of comparing the prediction can comprise comparing the prediction for each of the N data practices with entries in the data practice label for the data system to identify the possible discrepancy between the prediction and the data practice label.

In various implementations, the classifier comprises an ensemble of N-classifiers, and each of the N classifiers is trained, through machine learning, to generate the prediction of a respective one of the N data practices. In that connection, each of the N classifiers can be trained to generate the prediction for one and only one data practice.

In various implementations, the method further comprises, prior to applying the data practice policy to the classifier, training, by the computer system, the classifier, using machine learning, to generate the prediction of whether the data practice policy is indicative of the data system disclosing the attribute of given data practice. Training the classifier can comprise training the classifier with a plurality of data samples, where each data samples comprises a data practice policy for a sample data system and a data practice label for the sample data system.

In various implementations, the method further comprises, prior to applying the data practice policy to the classifier, training, by the computer system, each of the N classifiers in the ensemble to generate the prediction of the respective one of the N data practices.

Training the classifiers can comprise training each of the N classifiers with a plurality of data samples, where each data samples comprises a data practice policy for a sample data system and a data practice label for the sample data system.

In various implementations, applying to the data practice policy the classifier comprises using prompt engineering with a foundation model for the given data practice covered by the data practice label to generate the prediction of whether the data practice policy is indicative of the data system disclosing the attribute for the given data practice. The prompt engineering can comprise providing to the foundation model a detailed definition of the given data practice; using an exact definition of the given data practice as found in documentation for the data practice label; and/or providing in a prompt at least one example of data practice policy text indicative of a data system engaging in the given data practice.

In various implementations, the prediction comprises one of three alternatives: (a) the data practice policy is indicative of the data system being permitted to engage in the data practice; (b) the data practice policy is indicative of the data system not being permitted to engage in the data practice; or (c) the data practice policy not being indicative of either (a) or (b).

In various implementations, the classifier comprises a large language model.

In various implementations, the method further comprises, after comparing, upon identification of a possible discrepancy, flagging, by the computer system, in an electronic data file, the possible discrepancy. The electronic data file can comprise a database file. The database file includes a field for marking whether a possible discrepancy was identified for the data system. Flagging the possible discrepancy can comprise identifying the given data practice and a type of discrepancy that has been identified. Flagging the possible discrepancy can further comprise identifying at least one relevant segment of text in the data practice policy that led the classifier to identify the possible discrepancy for the given data practice.

Flagging the discrepancy can further comprises producing, by the computer system, a report with at least the possible discrepancy.

In various implementations, the method further comprises, after comparing, by the computer system, upon a determination of no possible discrepancies, a reporting identifying that no possible discrepancies were identified.

In various implementations, the method further comprises, after comparing, upon identification of a possible discrepancy, transmitting, by the computer system, the possible discrepancy to a digital platform associated with the data system.

In various implementations, the method further comprises, after comparing, upon identification of a possible discrepancy, transmitting, by the computer system, the possible discrepancy to a regulator associated with the given data practice.

In various implementations, the method further comprises, after comparing, upon identification of a possible discrepancy, transmitting, by the computer system, the possible discrepancy to an entity responsible for the data system.

In various implementations, the method further comprises generating, by the computer system, a human readable summary that comprises a summary of the prediction, such as a human readable summary of predictions by the N classifiers.

In various implementations, training the classifier further comprises: grouping a subset of a plurality of sample data systems based on the data practice policy for each of the sample data systems; comparing, with each other, each of the respective data practices disclosed in the data practice label of each data system of the subset of the plurality of sample data systems; and generating a probability that a new data practice policy comprising characteristics of the data practice policies for the subset of the plurality of sample data systems has the same data practices as the respective data practices provided on the data practice labels of the subset of the plurality of sample data systems; and training the classifier to correlate the new data practice policy comprising characteristics of the data practice policies for the subset of the plurality of sample data systems with the respective data practices provided on the data practice labels for the subset of the plurality of sample data systems.

In various implementations, the N classifiers have non-homogenous model architectures. In various implementations, two or more classifiers of the N classifiers have the same model architecture.

In various implementations, at least one classifier of the N classifiers comprises a machine learning architecture model selected from the group consisting of a logistic regression model, a large language model, a transformer-based model, and a multilayer perceptron model, a recurrent neural network, and a graph neural network.

In various implementations, the method further comprises performing, by the computer system, an analysis of software code for the data system; and identifying the possible discrepancy further comprises identifying the possible discrepancy additionally based on the analysis of the software code. The analysis of the software code can comprise determining data sent by the data system to a third party while the data system is operating.

In various aspects, each of the aforementioned aspects, implementations, and/or examples of methods can be executed by a computer system comprising a processor and a memory coupled to the processor. The memory stores the nodal network comprising a first node and a second node, the first and second nodes comprising activation functions that are evaluable on a dataset according to an objective defined by an objective function. Further, the memory stores the steps of the methods as instructions that, when executed by the processor, cause the computer system to perform the method steps.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

Whereas particular examples of this invention have been described above for purposes of illustration, it will be evident to those skilled in the art that numerous variations of the details of the present invention may be made without departing from the invention as defined in the appended claims.

While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

It is understood that the inventions described in this specification are not limited to the examples summarized in the Summary or Description. Various other aspects are described and exemplified herein.

1. A method for identifying potential discrepancies between data practice disclosures made in a data practice policy and a data practice label for a data system, the method comprising:
applying to the data practice policy a classifier for a given data practice covered by the data practice label to generate a prediction of whether the data practice policy discloses an attribute of the given data practice for the data system, wherein the classifier runs on a computer system; and
comparing, by the computer system, the prediction for the given data practice with an entry in the data practice label for the data system to identify a possible discrepancy between the prediction and the data practice label.

2. The method of claim 1, wherein the classifier is trained to make predictions via machine learning.

3. The method of claim 1, wherein:
there are N>1 data practices covered by the data practice label;
applying to the data practice policy the classifier comprises applying to the data practice policy the classifier for each of the N data practices covered by the data practice label to generate a prediction of whether the data practice policy discloses an attribute of each of the N data practices for the data system; and
comparing the prediction comprises comparing the prediction for each of the N data practices with entries in the data practice label for the data system to identify the possible discrepancy between the prediction and the data practice label.

4. The method of claim 3, wherein:
the data practice policy comprises a data privacy policy for the data system;
the N data practices comprise at least one affirmative data practice; and
the N data practices comprise at least one negative data practice.

5. The method of claim 3, wherein:
the classifier comprises an ensemble of N classifiers; and
each of the N classifiers is trained, through machine learning, to generate the prediction of a respective one of the N data practices.

6. The method of claim 5, wherein each of the N classifiers is trained to generate the prediction for one and only one data practice.

7. The method of claim 1, further comprising, prior to applying the data practice policy to the classifier, training, by the computer system, the classifier, using machine learning, to generate the prediction of whether the data practice policy disclose the attribute of the given data practice for the data system.

8. The method of claim 7, wherein training the classifier comprises training the classifier with a plurality of data samples, wherein each data samples comprises a data practice policy for a sample data system and a data practice label for the sample data system.

9. (canceled)

10. (canceled)

11. The method of claim 1, wherein applying to the data practice policy the classifier comprises using prompt engineering with a foundation model for the given data practice covered by the data practice label to generate the prediction of whether the data practice policy is indicative of the attribute of the given data practice for data system.

12. The method of claim 11, wherein using prompt engineering comprises providing to the foundation model a detailed definition of the given data practice.

13. (canceled)

14. The method of claim 11, wherein using prompt engineering comprises providing in a prompt at least one example of data practice policy text having the attribute of the given data practice.

15. (canceled)

16. (canceled)

17. The method of claim 1, wherein the classifier comprises a large language model.

18. The method of claim 1, further comprises, after comparing, upon identification of a possible discrepancy, flagging, by the computer system, in an electronic data file, the possible discrepancy.

19. (canceled)

20. The method of claim 1, wherein flagging the possible discrepancy comprises identifying the given data practice and a type of discrepancy that has been identified. and wherein flagging the possible discrepancy further comprises identifying at least one relevant segment of text in the data practice policy that led the classifier to identify the possible discrepancy for the given data practice.

21. (canceled)

22. (canceled)

23. (canceled)

24. (canceled)

25. (canceled)

26. (canceled)

27. The method of claim 1, further comprising, generating, by the computer system, a human readable summary that comprises a summary of the prediction.

28. The method of claim 5, further comprising, generating, by the computer system, a human readable summary of predictions by the N classifiers.

29. The method of claim 2, wherein training the classifier further comprises:
grouping a subset of a plurality of sample data systems based on the data practice policy for each of the sample data systems;
comparing, with each other, each of the respective data practices disclosed in the data practice label of each data system of the subset of the plurality of sample data systems; and
generating a probability that a new data practice policy comprising characteristics of the data practice policies for the subset of the plurality of sample data systems has the same data practices as the respective data practices provided on the data practice labels of the subset of the plurality of sample data systems; and
training the classifier to correlate the new data practice policy comprising characteristics of the data practice policies for the subset of the plurality of sample data systems with the respective data practices provided on the data practice labels for the subset of the plurality of sample data systems.

30. (canceled)

31. (canceled)

32. (canceled)

33. (canceled)

34. (canceled)

35. (canceled)

36. (canceled)

37. (canceled)

38. The method of claim 1, wherein the data practice policy comprises text of a government regulation.

39. (canceled)

40. The method of claim 1, wherein the data practice policy comprises a plurality of policy resources.

41. (canceled)

42. The method of claim 1, wherein:
the method further comprises performing, by the computer system, an analysis of software code for the data system; and
identifying the possible discrepancy further comprises identifying the possible discrepancy additionally based on the analysis of the software code.

43. The method of claim 42, wherein the analysis of the software code comprises determining data sent by the data system to a third party while the data system is operating.

44. A system for identifying potential discrepancies between data practice disclosures made in a data practice policy and a data practice label for a data system, the system comprising:
a computer system; and
a classifier running on the computer system to generate a prediction of whether the data practice policy discloses an attribute of the data practice covered by the data practice label for the data system; and
wherein the computer system is configured to identify a possible discrepancy between the prediction and the data practice label based on a comparison of the prediction for the data practice with an entry in the data practice label for the data system.

45. The system of claim 44, wherein the classifier is trained to make predictions via machine learning, and wherein:
there are N>1 data practices covered by the data practice label;
wherein the classifier is applied to the data practice policy for each of the N data practices covered by the data practice label to generate the prediction of whether the data practice policy discloses an attribute for each of the N data practices for the data system; and
the computer system is configured to compare the prediction for each of the N data practices with entries in the data practice label for the data system to identify the possible discrepancy between the prediction and the data practice label.

46. The system of claim 44, wherein:
there are N>1 data practices covered by the data practice label;
wherein the classifier is applied to the data practice policy for each of the N data practices covered by the data practice label to generate the prediction of whether the data practice policy discloses an attribute for each of the N data practices for the data system; and
the computer system is configured to compare the prediction for each of the N data practices with entries in the data practice label for the data system to identify the possible discrepancy between the prediction and the data practice label,
wherein:
the data practice policy comprises a data privacy policy for the data system;
the N data practices comprise at least one affirmative data practice;
the N data practices comprise at least one negative data practice. the classifier comprises an ensemble of N classifiers; and
each of the N classifiers is trained, through machine learning, to generate the prediction of a respective one of the N data practices.

47. (canceled)

48. (canceled)

49. (canceled)

50. (canceled)

51. (canceled)

52. (canceled)

53. (canceled)

54. The system of claim 44, wherein the data practice policy is applied to the classifier using prompt engineering with a foundation model for the data practice covered by the data practice label to generate the prediction of whether the data practice policy discloses the attribute of the data practice.

55. (canceled)

56. (canceled)

57. (canceled)

58. (canceled)

59. (canceled)

60. The system of claim 44, wherein the classifier comprises a large language model.

61. The system of claim 44, wherein:
upon identification of the possible discrepancy, the computer system flags, in an electronic data file, the possible discrepancy
flagging the possible discrepancy comprises identifying the data practice and a type of discrepancy that has been identified; and
flagging the possible discrepancy further comprises identifying at least one relevant segment of text in the data practice policy that led the classifier to identify the possible discrepancy for the data practice.

62. (canceled)

63. (canceled)

64. (canceled)

65. (canceled)

66. (canceled)

67. (canceled)

68. (canceled)

69. (canceled)

70. (canceled)
